(19) United States
(12) Patent Application Publication
(10) Pub. No.: US 2009/0327742 A1
(43) Pub. Date: Dec. 31, 2009

(54) METHOD FOR MANAGING MULTIUSER DIGITAL PHOTO FRAME

(75) Inventors: YI-FANG WU, Tu-Cheng (TW); Yan-Yan Zhang, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/240,971

(22) Filed: Sep. 29, 2008

(30) Foreign Application Priority Data
Jun. 30, 2008 (CN) 200810302448.3

(51) Int. Cl. H04L 9/32

(52) U.S. Cl. 713/183

(57) ABSTRACT

A method for managing multiple users on a digital photo frame is disclosed. The method includes: adding a user account on the digital photo by a user inputting a username and a password, associating files with the username, prompting users to enter the username and password associated with the files to access the files and determining whether the username and password are correct, and if they are, allowing the user to access the files.

### BACKGROUND

1. Technical Field

The present invention relates to a method for managing multiple user accounts in a digital photo frame.

2. Description of Related Art

A typical digital photo frame (DPF) is capable of storing many different types of media files, such as for photos and songs. However, some users may want to keep certain files private.

Therefore, there is room for improvement within the art.

### BRIEF DESCRIPTION OF THE DRAWINGS

FIG. 1 is a Graphical User Interface (GUI) of an embodiment of a DPF allowing the adding of user accounts to a DPF;

FIG. 2 is a GUI of an embodiment of a DPF allowing a user to sign in to their account in the DPF;

FIG. 3 is a flow chart for a method used with the GUI of FIG. 2;

FIG. 4 is a GUI of an embodiment of DPF for viewing photos using the DPF; and

FIG. 5 is a flow chart for a method used with the GUI of FIG. 4.

### DETAILED DESCRIPTION OF THE EMBODIMENTS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

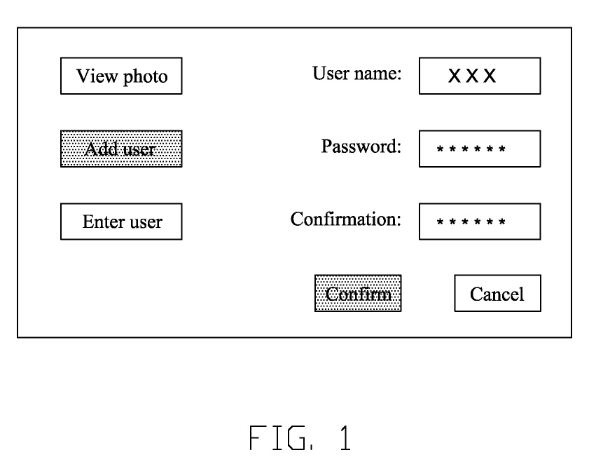

FIG. 1 is a Graphical User Interface (GUI) of an embodiment of a DPF allowing the adding of user accounts to a DPF. A user name, password, and password confirmation are entered, and once completed the account is set up. Any files loaded under that account are only accessible under that account. Thus, the files associated with that account are encrypted under the user name and the password. To access these files, a person must sign in with the user name and password associated with the files. Ranks of all accounts in the DPF are same, and there is no a master user. Files loaded to the DPF without an associated user account are unencrypted and may be used by anyone whether they are signed in or not.

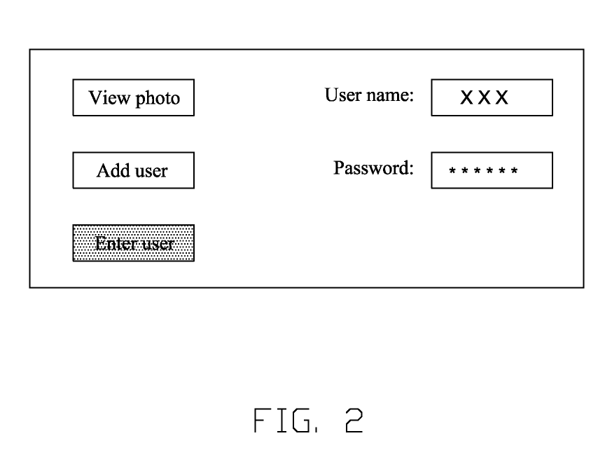

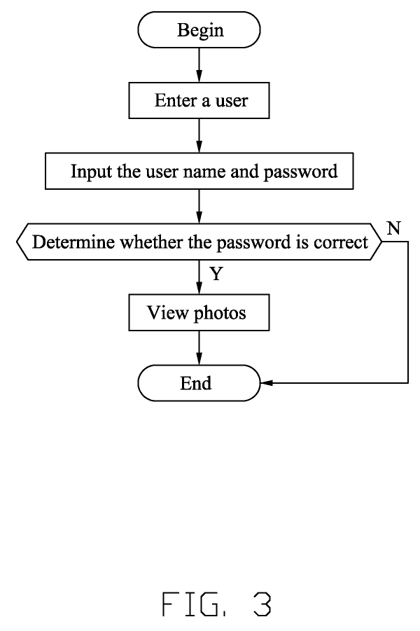

FIG. 2 is a GUI of an embodiment of a DPF allowing a user to sign in to their account in the DPF. FIG. 3 is a flow chart for a method used with the GUI of FIG. 2. The method of entering the user account includes the following steps: selecting to enter the user account; inputting the user name and password; determining whether the password is correct; and using files associated with that user account if the password is correct. Thus, if the user signs in correctly, they will be access encrypted files associated with that account.

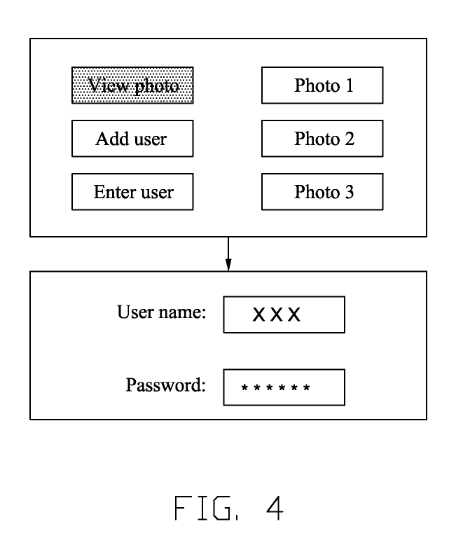

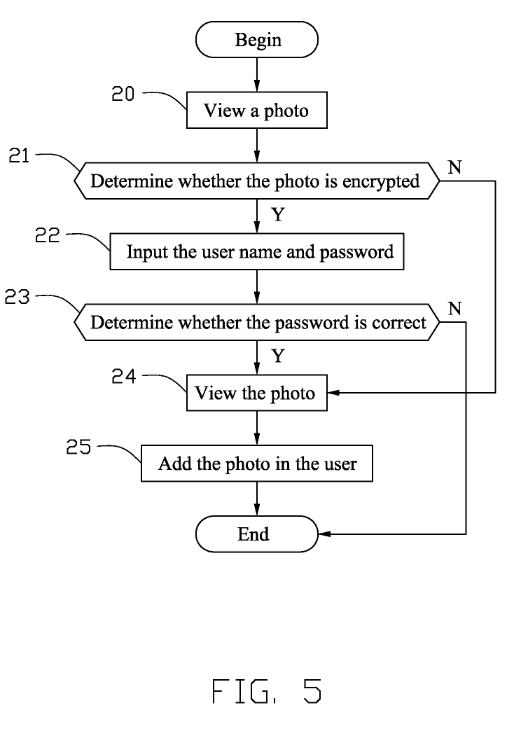

FIG. 4 is a GUI of an embodiment of DPF for viewing photos using the DPF. FIG. 5 is a flow chart for a method used with the GUI of FIG. 4. Depending on the embodiment, certain of the steps described below may be removed, others may be added, and the sequence of steps may be altered.
Step 20: the user selects a photo from a name list of photos (e.g. Photo 1, Photo 2, Photo 3) that is displayed on the DPF.
Step 21: the method determines whether the selected photo 1 is associated with a user name and therefore encrypted. If the photo 1 is encrypted, proceed to Step 22; if not, skip to Step 24.
Step 22: the user inputs the user name and password associated with the selected photo file.
Step 23: the DPF determines whether the user name and password are correct. If the password is correct, proceed to Step 24; if not, the DPF may prompt the user to try and again or indicate the process may be ended.
Step 24: the selected photo 1 is displayed for viewing.
Selectable Step 25: the user may or may not add the photo 1 to his account.

It is to be understood, however, that even though numerous characteristics and advantages of the present embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A method for managing multiple users on a digital photo frame, comprising:
adding a user account on the digital photo frame by a user inputting a username and a password;
associating files with the username;
prompting users to enter the username and password associated with the files to access the files; and
determining whether the username and password are correct, and if they are, allowing the user to access the files.

2. The method of claim 1, further comprising viewing a list of the files loaded into the digital photo frame, selecting one of the files from the list; determining whether the selected one of the files is encrypted; and allowing access to one of the files if the username and password associated with the one of the files are input correctly.

3. The method of claim 2, further comprising allowing a properly signed-in user to the selected one of the files to their own username.
